(19) United States
(12) Patent Application Publication
(10) Pub. No.: US 2012/0113899 A1
(43) Pub. Date: May 10, 2012

(54) COMMUNICATIONS APPARATUS, SYSTEM AND METHOD

(75) Inventor: Anthony Overmars, Balwyn North (AU)

(73) Assignee: MOIP PTY LTD, BALWYN NORTH (AU)

(21) Appl. No.: 13/318,419

(22) PCT Filed: May 19, 2010
(86) PCT No.: PCT/AU10/00585

§ 371 Date: Jan. 23, 2012

(30) Foreign Application Priority Data
May 19, 2009 (AU) 2009902240
Dec. 15, 2009 (AU) 2009906083

(51) Int. Cl. H04W 4/00

(52) U.S. Cl. 370/328

(57) ABSTRACT

The present invention relates to the field of communications apparatus, systems and method(s) of communication. In one form, the invention relates to a mobile phone device and it's associated systems and method(s) of communication. More particularly, the present invention, in aspect of invention, relates to a mobile VoIP (Voice Over Internet Protocol) device. In one particular aspect the present invention a mobile internet phone (MIP).

### FIELD OF INVENTION

The present invention relates to the field of communications apparatus, systems and method(s) of communication. In one form, the invention relates to a mobile phone device and its associated systems and method(s) of communication. More particularly, the present invention, in aspect of invention, relates to a mobile VoIP (Voice Over Internet Protocol) device.

In one particular aspect the present invention a mobile internet phone (MIP).

It will be convenient to hereinafter describe the invention in relation to an MIP, however it should be appreciated that the present invention is not limited to that use only.

### BACKGROUND ART

Throughout this specification the use of the word “inventor” in singular form may be taken as reference to one (singular) inventor or more than one (plural) inventor of the present invention.

For many years now the mobile phone has been based upon a direct pier to pier connection between a mobile phone and a mobile phone tower and conversations occurred over a dedicated voice channel. This is also accomplished using circuit switched networks.

Universal Mobile Telecommunications System (UMTS) is one of the third-generation (3G) mobile telecommunications technologies, which is also being developed into a 4G technology. Currently, the most common form of UMTS uses W-CDMA as the underlying air interface. UMTS and its use of W-CDMA is standardized by the 3GPP, and is the European answer to the ITU IMT-2000 requirements for 3G cellular radio systems.

Using a cellular router, PCMCIA or USB card, enables access to 3G broadband services, regardless of the choice of computer (such as a tablet PC or a PDA). Some software installs itself from the modem, so that in some cases absolutely no knowledge of technology is required to get online.

Using a phone that supports 3G and Bluetooth 2.0, multiple Bluetooth-capable laptops can be connected to the Internet. The phone acts as gateway and router, but via Bluetooth rather than wireless networking (802.11) or a USB connection.

A schematic representation of this UMTS architecture is illustrated in FIG. 1. A mobile phone 10, communicates with a tower 11, which inturn feeds communications traffic to an exchange (PSTN) 12. The traffic is then routed to via landline to a landline phone 13, or if a mobile phone is being called, the traffic is routed to another tower 14 and in turn to the destination mobile phone 15. In essence the telephone system assigns a dedicated circuit for the communication call.

In another configuration, voice over internet or VoIP is possible. Voice communication between parties became possible using what is today known as Voice over Internet Protocol or VoIP. Voice-over-Internet protocol is a protocol optimized for the transmission of voice through the internet or other packet-switched networks. VoIP is often used abstractly to refer to the actual transmission of voice (rather than the protocol implementing it). This latter concept is also referred to as IP telephony, Internet telephony, voice over broadband, broadband telephony, and broadband phone.

VoIP providers may be viewed as commercial realizations of the experimental Network Voice Protocol (1973) invented for the ARPANET providers. Some cost savings are due to utilizing a single network to carry voice and data, especially where users have underused network capacity that can carry VoIP at no additional cost. VoIP-to-VoIP phone calls are sometimes free, while VoIP calls connecting to public switched telephone networks (VoIP-to-PSTN) may have a cost that is borne by the VoIP user. Voice-over-IP systems carry telephony signals as digital audio, typically reduced in data rate using speech data compression techniques, encapsulated in a data-packet stream over IP. There are two types of PSTN-to-VoIP services: Direct inward dialing (DID) and access numbers. DID will connect a caller directly to the VoIP user, whilst access numbers require the caller to provide an extension number for the called VoIP user.

A schematic representation of the VoIP system is illustrated in FIG. 2. An IP phone 20 is connected to a VoIP router, which is connected to a modem 22 and in turn to the internet 23. The communication is feed to a SIP Server 24 which establishes an IP address to the phone and then routes the RTP packets over the IP session to a Proxy server 25. The communication is then routed to a PSTN or GSM gateway 26.

Alternatively, a computer or other device can be connected directly to the modem 22 and provide communication via the VoIP system.

In a further alternative, a wireless LAN IP phone 28 may communicate with a wireless modem 29, which in turn communicates with the internet 23.

In still a further alternative, a wireless LAN IP phone 30 may communicate wirelessly to a WWAN 31 (wireless WAN), with integrated router and modem communicating wirelessly to the internet 23.

With regard to integration into global telephone number system, while the wired public switched telephone network (PSTN) and mobile phone networks share a common global standard (E.164) which allocates and identifies any specific telephone line; there is no widely adopted similar standard for VoIP networks. Some allocate an E.164 number which can be used for VoIP as well as incoming and external calls. However, there are often different, incompatible schemes when calling between VoIP providers which use provider-specific short codes.

With regard to VoIP phone accessibility and portability, if using a software based soft-phone, calls can only be placed from the computer on which the soft-phone software resides. Thus with a soft-phone the caller is typically limited to a single point of calling. When using a hardware based VoIP phone-device/phone-adapter it is possible to connect traditional analog phones directly to a VoIP phone-adapter without the need to operate a computer. The converted analog phone signal can then be connected to multiple house phones or extensions, just as any traditional phone company signal can be connected. A second VoIP hardware configuration option involves the use of a specially designed VoIP telephone which incorporates a VoIP phone adapter directly into the phone itself, and which also does not require the use of a computer. A third VoIP hardware configuration option involves the use of a WiFi router and a WiFi SIP phone which can extend a service range throughout a home or office. WiFi SIP phones can also be used at any location where an “unauthenticated” open hotspot Wi-Fi signal is available However, note that many hotspots require browser-based authentication, which most SIP phones do not support.

With regard to mobile phones and hand-held devices, telcos and consumers have invested billions of dollars in mobile phone equipment. In developed countries, mobile phones have achieved nearly complete market penetration, and many people are giving up landlines and using mobiles exclusively. Given this situation, it is not entirely clear whether there would be a significant higher demand for VoIP among consumers until either public or community wireless networks have similar geographical coverage to cellular networks (thereby enabling mobile VoIP phones, so called WiFi phones or VoWLAN) or VoIP is implemented over 3G networks. However, “dual mode” telephone sets, which allow for the seamless handover between a cellular network and a WiFi network, are expected to help VoIP become more popular.

Phones like the NEC N900iL, and later many of the Nokia E-series and several WiFi enabled mobile phones have SIP clients hardcoded into the firmware. Such clients operate independently of the mobile phone network unless a network operator decides to remove the client in the firmware of a heavily branded handset. Some operators such as Vodafone actively try to block VoIP traffic from their network and therefore most VoIP calls from such devices are done over WiFi.

Several WiFi only IP hardphones exist, most of them supporting either Skype or the SIP protocol. These phones are intended as a replacement for PSTN based cordless phones but can be used anywhere where WiFi internet access is available.

With the introduction of HSDPA/HSUPA standards, high speed data became possible in a mobile wireless implementation at higher rates than GPRS.

High-Speed Downlink Packet Access (HSDPA) is a 3G (third generation) mobile telephony communications protocol in the High-Speed Packet Access (HSPA) family, which allows networks based on Universal Mobile Telecommunications System (UMTS) to have higher data transfer speeds and capacity. Current HSDPA deployments support down-link speeds of 1.8, 3.6, 7.2 and 14.4 Mbit/s. Further speed increases are available with HSPA+, which provides speeds of up to 42 Mbit/s downlink. The High-Speed Downlink Shared Channel (HS-DSCH) lacks two basic features of other W-CDMA channels—variable spreading factor and fast power control. Instead, it delivers the improved downlink performance using adaptive modulation and coding (AMC), fast packet scheduling at the base station, and fast retransmissions from the base station, known as hybrid automatic repeat-request (HARQ).

During 2007, an increasing number of telcos worldwide began selling HSDPA USB modems as mobile broadband connections. In addition, the popularity of HSDPA landline replacement boxes grew—providing HSDPA for data via Ethernet and WiFi, and ports for connecting traditional landline telephones. These were marketed with connection speeds of “up to 7.2 Mbit/s”, which is only attained under ideal conditions. As a result, these services can be slower than expected, especially when in fringe coverage indoors. However, signal strength can be greatly improved by using commercial solutions that can attach 3G external antennas.

The inventor has realised that Mobile Handheld Devices (MHDs) have a number of limitations, such as:
MHDs consume services rather than supply services.
MHDs are endpoint devices that run consumer applications. These applications include voice calls, video calls, and data services for client applications such as web browsing, email, time synchronisation, Wireless Application Protocol (WAP), Short Message Service (SMS), Multi-media messaging service (MMS), Point to Point Protocol (PPP), video feeds etc.
MHDs are a single user device
MHDs lack an integrated Internet Protocol (IP) address routing capability. This makes them unsuitable for network applications such as IP routing, Domain Name Service (DNS) servers.
MHDs lack an ability to run virtual services such as Virtual Private Networks (VPNs) and multiple Virtual Machines (VMs).
Tariffs for MHDs are high for voice channels (circuit switched) compared to landline or fixed line telephone services. Typically the tariffs are made up of fixed costs such as line rental and device rental; and variable costs, such as connection costs, time costs and distance costs.
Whilst MHDs support data services, the provision of mobile data services are coupled with voice service contracts.
Softphone applications which provide Voice over Internet Protocol (VoIP) functions that run on MHDs use either WiFi LAN connections or route through circuit switched networks
The operating systems run by MHDs are fixed. They are designed to work exclusively with the MHD hardware.
MHD applications are insulated by the operating system provided by the MHD vendor from controlling the underlying hardware.

In addition, the inventor has identified certain features regarding the use of Circuit-switched vs Packet-switched networks. In the case of circuit switched networks, the tariffs are geared towards timed calls over long distances and/or interconnection to other networks e.g. mobile or Voice Over Internet Protocol (VoIP). In the case of packet switched networks, the tariffs are geared towards data volume rather than connection time.

In addition, the inventor has identified certain features related to Voice vs Data services. Carrier providers, such as telecommunication providers, choose to separate voice services from data services to maintain a tariff structures.
Public Switched Telephone Network (PSTN) Carriers choose to provide voice services over an analogue fixed line and/or data services via Asymmetric Digital Subscriber Line (ADSL) service.
Cable Carriers provide data services via Digital Subscriber Loop (DSL) service.
Mobile Carriers choose to provide voice services over circuit switched network and data over the packet switched network.

The inventor has further identified the following problems with the delivery of mobile voice services.
Mobile handheld devices are used as endpoint, devices with separate channels for voice and data. The voice channel is dedicated to voice only. The data channel is limited to modem functions only.
Mobile handheld devices use the voice channel for delivery of voice services. This channel is dedicated and therefore can be relatively expensive compared to a landline or fixed line telephone service.
Current handheld wireless device technologies are limited to end-point applications such as web browsing, email, time synchronisation, Wireless Application Protocol (WAP), Short Message Service (SMS), Multi-media messaging service (MMS), Point to Point Protocol (PPP), video feeds etc. They are yet to be able to provide more complex functions such as Voice Over Internet Protocol (VOIP), Virtual Private Network (VPN), Video Conferencing. This is because it would require the mobile devices to have a fixed endpoint address allocated to it.
Low cost VOIP services are currently available over fixed Internet connections.
Multiple devices are required to deliver VOIP service over wide area wireless networks such as Third Generation (3G), Fourth Generation (4G), Worldwide Interoperability for Microwave Access (WiMAX), Universal Mobile Telecommunications System (UMTS).
Cost of applications running in remote geographic areas such as telemetry and control devices.

Wireless Wide Area Networks (WWANs) can be accessed by many devices including Handheld devices. The following is a list of WWAN handheld device limitations:
Phones. Limitation is both voice and data. Endpoint device.
Internet Media Players e.g. MP3, IP-TV. Limitation is no voice. Endpoint device.
WWAN Personal Computer (PC) e.g. Web browsing. Endpoint device.
WWAN data collection devices e.g. bar coders, terminals. No voice. Not interactive.
Endpoint devices. Limitations
   Single user
   Not a server
   Shared WWAN are not handheld

Modems enable remote connections to the internet. Broadly there are wired modems and wireless modems. Wireless modems may be discrete or integrated. Integrated wireless modems may be handheld or non-handheld.

Discrete Wireless Modems are those that are separate from a host device. They include Universal Serial Bus (USB) modems, CardBus modems, Peripheral Component Interconnect (PCI) modems. Host devices include a Personal Computer (PC) or laptop computer. Essentially these discrete wireless modems are peripheral devices that provide modulation and demodulation functions.

Wireless modems that are integrated with handheld devices include mobile phones, Personal Digital Assistants (PDAs), smartphones, video phones or any other handheld phone device. Essentially the modem is an auxiliary function to the main function of the MHD which is to provide voice over the circuit switched network and personalised data functions such as email, diary, contact lists, reminders, games etc.

Wireless modems integrated with non-handheld devices include home and business products aimed at internet access using Wireless Wide Area Network (WWAN). Often these products include switched circuit voice capabilities.

The inventor has identified a number of limitations with wireless modems.
Discrete wireless modems are used in conjunction with non handheld devices
Handheld devices that integrate wireless modems have both data functions and voice functions. The data functions are provided using wireless modems interfacing to a packet switched network. The voice functions are provided by interfacing to a circuit switched telephone network such as the Public Switched Telephone Network (PSTN).
Handheld mobile devices are personalised.
Standard protocols such as Global System for Mobile communications (GSM) and Universal Mobile Telecommunications System (UMTS). The data services are delivered over standard protocols such as General Packet Radio Service (GPRS), Third Generation (3G), Fourth Generation (4G), Worldwide Interoperability for Microwave Access (WiMAX), and UMTS.
Mobile Network Node. It may also be referred to as a Mobile Server or a Mobile Landline.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

### SUMMARY OF INVENTION

An object of the present invention is to provide an improved communications apparatus, systems and method(s) of communication.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a mobile telecommunications device and/or method comprising a first interface adapted to communicate with a telecommunications network, a second interface adapted to receive and/or transmit audio communication and provide audio data, wherein the mobile device is adapted to transcribe the audio data into an IP packet.

In another aspect of embodiments described herein there is provided a method of and/or device adapted to transcribe an audio signal for communication with a telecommunications network, comprising providing audio data, providing an encoded signal by incorporating the audio data into an IP packet compatible with the network.

In yet a further aspect of embodiments described herein there is provided a method of and/or device for communicating on a telecommunications network, comprising providing an IP address to a MIP, establishing a SIP session with a carrier service provider, and enabling audio traffic as packet data between the network and the MIP.

In yet a still further aspect of embodiments described herein there is provided a telecommunications system and/or method, comprising a mobile device adapted to communicate audio communication, the telecommunications network being adapted to provide packet data to and from the mobile device wherein the packet data is derived from the audio communication.

Other aspects and preferred forms are disclosed in the specification and/or defined in the appended claims, forming a part of the description of the invention.

In essence, embodiments of the present invention stem from the realization that the communications device, system and methods are no longer used in conjunction with circuit switched technology, but are now instead used to work in conjunction with packet switched technology. Thus, the principle method deployed here is to route voice via the packet (data) switched network as opposed to the traditional method which uses the circuit switched network. This means a landline number (such as DID) and/or a mobile number and/or an IP address, can be assigned or associated with a mobile device and that any combination of multiple landline and/or mobile numbers and/or IP addresses can now be associated with each other on the one mobile internet phone (MIP). This manifests itself, in one form as a MIP (Mobile Internet Phone). MIP is a newly coined word to describe the device, method and/or system of the present invention. By using packet switched technology, the MIP then has migrated from the circuit switching technology used by prior art mobile phones around the world, to the packet switched technology which allows us to transmit the voice as data packets over the internet using a MIP or handheld internet voice enabled device. In other words, the present invention has established a new manner of communication between a mobile voice enabled device (MIP) and a SIP server for voice traffic.

For example, a SIP phone which currently accesses the network via Ethernet port or WLAN port will in accordance with the present invention be reconfigured to integrate a WWAN (Wireless WAN) port with a router (with Ethernet) into the SIP phone.

Another example is to reconfigure a WLAN, modem and router with Ethernet into SIP phone.

Advantages provided by the present invention comprise the following:
Simplicity and reduced cost of the device because it just requires support for the data switched network.
Reduced cost of operation of the device

Applications include
Enables inbound calls directed to a landline number to be delivered/received on a mobile device
Enables outbound calls to be made from a mobile device using a DID (landline number identifier)
Enables landline numbers (one or more) to coexist with mobile numbers (one or more) on the one device
Enables calls to be made between mobile devices using one or more IP addresses which can coexist on the one mobile device
Enables calls between mobile devices and landline devices and IP address based devices in any of the combinations outlined above
Enables inbound calls to “ring” a number of devices simultaneously, either by some type of IP address association or associations formed between the IP addresses and/or the mobile and/or landline devices
Enables calls to be placed between IP addresses with external caller verification
Enables calls to be placed between IP addresses without the need for any external caller verification
Enables calls to be placed between multiple IP addresses with or without external verification
Wireless Hotspot
Telemetry
Pocket hotspot
Mobile landline
Mobile VoIP in a mobile phone

Throughout this specification, MIP includes a mobile phone, cell phone, any mobile device, pocket device, handheld device, any other mobile device, all of which are configured to communicate voice traffic via packet switched technology.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates a schematic representation of a prior art UMTS architecture;

FIG. 2 illustrates a schematic representation of a prior art VoIP system;

FIG. 3 illustrates a schematic of a MIP (Mobile Internet Phone) communications system according to an aspect of the present invention;

FIG. 4 illustrates schematically various internal features of a MIP adapted to operate in a MIP system according to the present invention;

FIG. 5 illustrates an alternative MIP system according to another aspect of the present invention;

FIG. 6 illustrates a second embodiment according to an aspect of the present invention;

FIG. 7 illustrates a third embodiment according to an aspect of the present invention, and

FIG. 8 illustrates a fourth embodiment according to an aspect of the present invention.

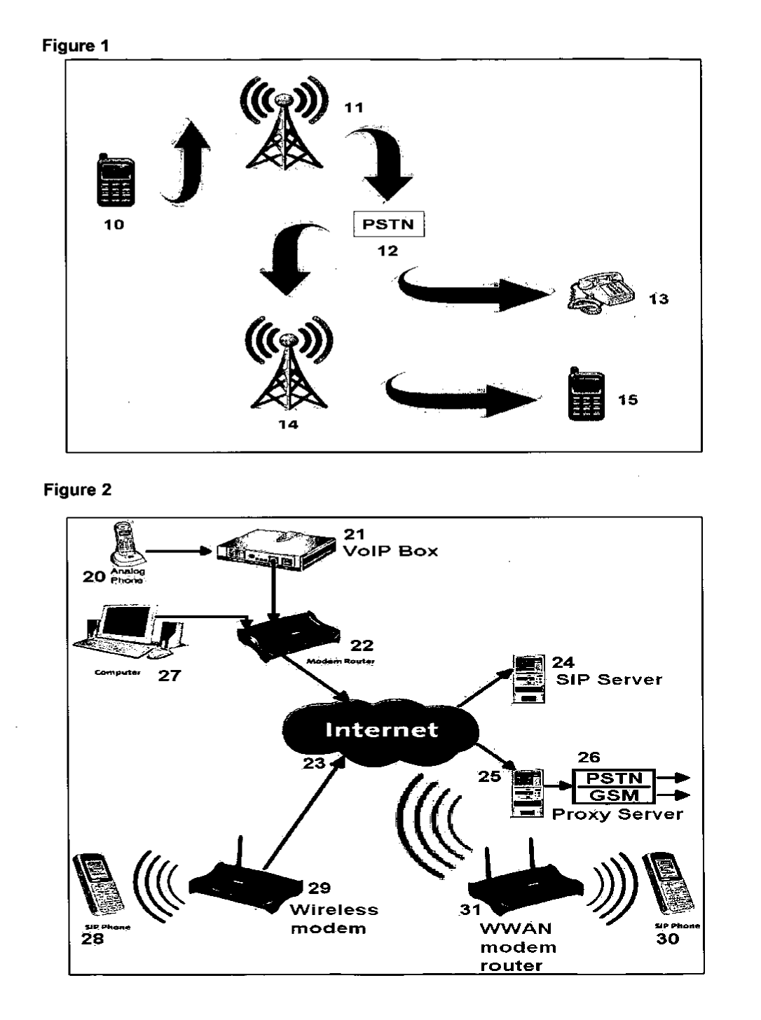

### DETAILED DESCRIPTION

In general, the principle method deployed in the present invention is to route voice via the packet (data) switched network as opposed to the traditional method which uses the circuit switched network. By doing this the phone would then have actually migrated from the circuit switching technology used by prior art mobile phones around the world, to the packet switching technology which allows the transmission of voice as data packets over the internet.

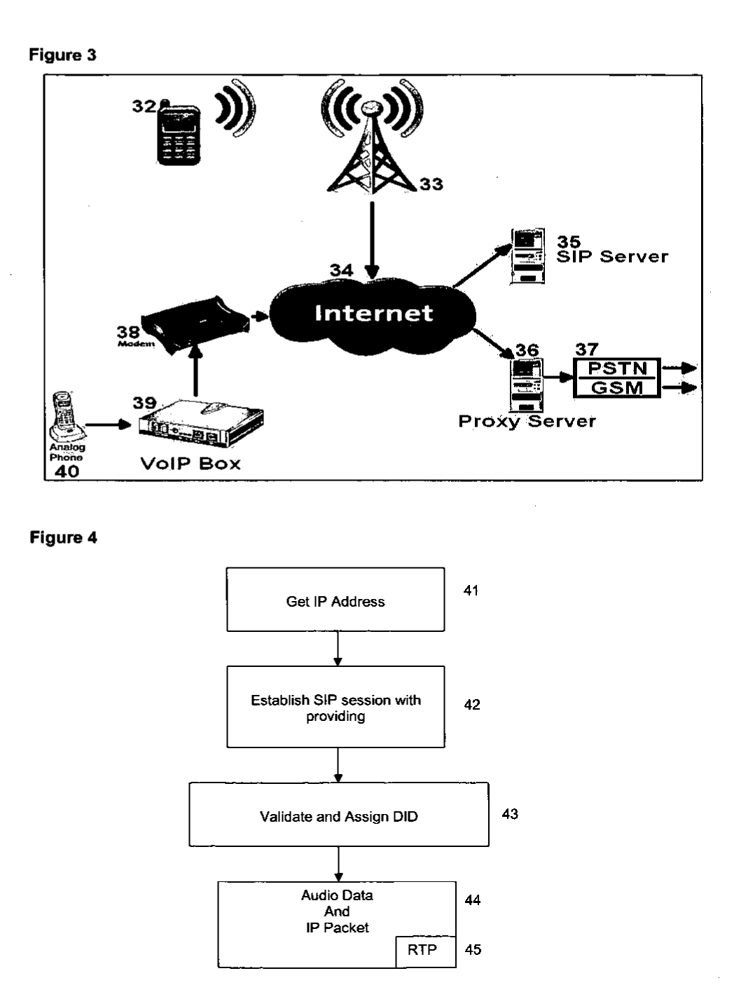

FIG. 3 illustrates a schematic of a MIP (Mobile Internet Phone) communications system according to an aspect of the present invention. A mobile phone 32 is adapted to communicate with a tower 33. Importantly, in accordance with the present invention, communication between the mobile phone 32 and the tower 33 is configured for the packet switched network only, not the circuit switched network (as is currently used in the prior art). In other words, the circuit switched features of the phone are not required to establish a voice call. In another embodiment, the circuit switched features are disabled. The tower 33 then also communicates with the internet 34, which in turn communicates with a SIP server 35, proxy server 36 and PSTN/GSM gateway 37 in accordance with existing systems and protocols.

In the case of the present invention, the packet switch technology provides data traffic (digital representations of text, sound, or video data) split into chunks, called packets that are then routed over a shared network. To accomplish this, the original message/data is segmented into several smaller packets. Each packet is then labelled with its destination and the number of the packet. This precludes the need for a dedicated path to help the packet find its way to its destination. Each packet is dispatched and may go via different routes. At the destination, the original message/data is reassembled, if necessary, in the correct order, based on the packet number and other statistically determined factors. In each network node, packets are queued or buffered, resulting in variable delay. This contrasts with circuit switching (as used by prior art for voice traffic) which sets up a specific circuit with a limited number of constant bit rate and constant delay connections between nodes for exclusive use during the communication session.

Furthermore, it is possible to enable concurrent SIP sessions. This is illustrated in FIG. 3 with the use of a modem 38, VoIP box 39 and an analogue phone 40. Because the SIP server can assign multiple IP addresses to one DID, numerous devices may communicate concurrently with other devices.

Similarly the SIP server can assign multiple DIDs to one IP address, in this way phone numbers from different geographic locations (for example Sydney or Melbourne) can be assigned to the one MIP and in addition one or more mobile numbers can also be assigned either in addition to geographic numbers or without geographic numbers.

FIG. 4 illustrates schematically various steps taken to establish communication in accordance with an aspect of the present invention.

In order to establish a connection between the MIP and a destination device (such as a SIP server, a proxy server, POTS, PSTN device and/or GSM device) the MIP may request an IP address 41 from the telecommunications network (dynamically assigned IP address) or it may advise telecommunications network of its IP address (fixed IP address). Using the IP address, a session can be established with a carrier service provider. The carrier service provider may supply a carriage service to the public using a telecommunications network unit and may include organisations that resell time on a carrier network for phone calls, provide access to the internet (Internet Service Providers) or provide telephone services over the internet (VoIP service providers). The users account details may be validated 43 with the provider. Once the account is validated, the account information is provided to the SIP (or proxy) server which establishes a session between the IP address of the SIP (or proxy) server and the telecommunications network assigned IP address of the MIP. The SIP (or proxy) server also routes a valid DID to the MIP IP address. This results in a phone number being assigned to the MIP device providing a PSTN connection. As a result of the PSTN connection being assigned to the MIP, all voice traffic can be communicated between the MIP and the network as packet switched data traffic 44, not circuit switched traffic as is currently used by prior art devices, systems and methods. Preferably, a real time or other suitable protocol 45 to ensure correct ordering of packets at the receive end is also used in association with the present invention.

### First Embodiment

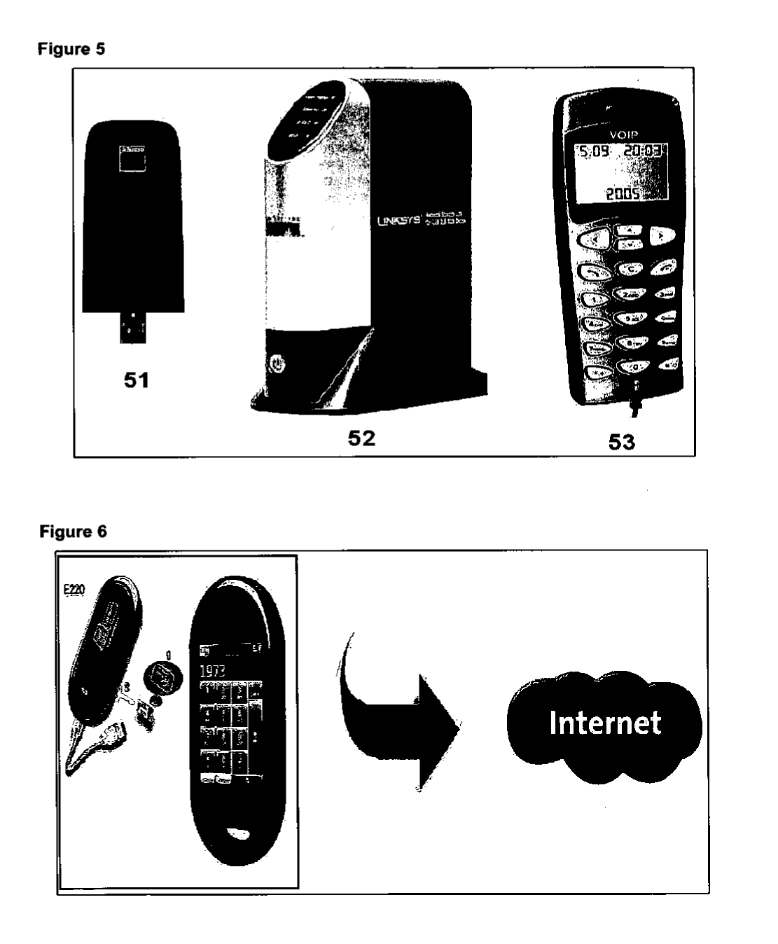

The MIP enables VoIP over HSDPA. The device combines the functions of three separate devices and combines these three devices to perform a new function with the aid of significant software integration between all of the respective sub-components. The three components are: (i) a HDSPA Modem 51; (ii) a Router 52; and (iii) a phone handset 53. as shown in FIG. 5.

i. HSDPA Modem

An example of a HSDPA modem is the Huawei E220. The Huawei HSDPA access device (‘modem’) manufactured by Huawei is notable for using the USB interface (USB modem). Similar devices are the GlobeSurfer iCON 7.2 and the Sierra Wireless 880U. Launched on 21 Jun. 2006, the Huawei E220 is used for wireless Internet access using 3.5G, 3G, or 2G mobile telephony networks. It supports UMTS (including HSDPA), EDGE, GPRS and GSM. E220 works well with Linux, as support for it was added in Linux kernel 2.6.20, but there are workarounds for distributions with older kernels (eg for Debian etch's 2.6.18). The card is also supported by Vodafone Mobile Connect Card driver for Linux, and it is possible to monitor the signal strength through other Linux applications. Most 3G network operators bundle the device with a contract, with some operators simlocking the device. Unlocked and unbranded modems can also be bought from independent suppliers.

ii. Router (or Residential Gateway)

A Linksys NSLU2 router is used as the router which allows the connection of a LAN (used in the home, car or handheld) to a WAN (wide area network). The WAN can be the “Internet” or can merely be a larger LAN of which the home or car or handheld phones form as a part (such as a municipal WAN that provides connectivity to the mobile voip phones within the municipality).

Multiple devices have been described as “residential gateways”: Cable Modems or DSL modems, Routers or wireless routers, Switch, VoIP ATA, Wireless access points, or, any combination of the these. The router provides: IP address routing, network address translation (NAT), DHCP functions, firewall functions, LAN connectivity like a network switch. The router is a self-contained component, using internally-stored firmware based upon Linux. Note that the above function has also be achieved using a Wireless router (Linksys WRTSL54gs) performing the same functions as a router, and allowed connectivity for wireless devices including phones such as the Linksys WIP330 with the LAN, or between the wireless router and another wireless router. The wireless access point can function in a similar fashion to a modem. It can allow a direct connection from a home LAN to a WAN (or a car LAN to the WAN or a mobile hand held device such as a phone LAN to the WAN) if a wireless router or access point is present on the WAN as well.

iii. Phone Handset

The USB handset is a simple USB device consisting of a HID keyboard device an audio speaker device and an audio microphone device. All the device drivers for this are programmed into the firmware on the router.

### Function

In addition to these base functions described above the router has also been enable with SIP phone firmware and device drivers for the USB phone handset and the USB HSDPA Modem. The router has also been enabled to route process data packets to and from the USB handset and convert these to and from VoIP packets and then route these to and from the USB HSDPA Modem over the WWAN modem, thereby completing the function of a Mobile VoIP phone as it is embodied in the MIP.

The modem provides none of the functions of a router. It merely allows digital Ethernet data traffic to be modulated into analogue information suitable for transmission across wireless radio frequencies. Upon receiving the modem re-converts a transmission format back into digital data packets. This allows network bridging using wireless telephone radio connection methods. The modem also provides handshake protocols, so that the devices on each end of the connection are able to recognize each other. In this case a USB modem plugs into a USB port on the router and allows connection of that router to a WAN.

In the final version of the Mobile VoIP phone, as it is embodied in the MIP, it consists of an internal modem which can be installed in a phone handset, allowing that phone to connect to a WAN. The phone will need additional firmware to allow the processing and routing of VoIP data to and from the respective VoIP service providers. The phone can also provide the full functions of a router allowing devices near it⁻to connect to it and through it to the Wireless Wider Access Network (WWAN).

In this way the phone (or MIP) now not only becomes a voice over internet protocol (VoIP) device but a router providing access to the WAN as well.

### Second Embodiment

In a second embodiment, the present invention is implemented onto Openmoko™. A programmable mobile device, such as Openmoko™ can be used via its open software stack to deliver Mobile VoIP phone functionality as it is embodied in the MIP platforms. The Openmoko™ stack, allows users and developers to transform mobile hardware platforms into unique products. In this case the Openmoko™ platform is used to develop an intermediate MIP which also a HSDPA Modem to be connected to the Host USB port on the Openmoko™ phone as shown in FIG. 6.

### Third Embodiment

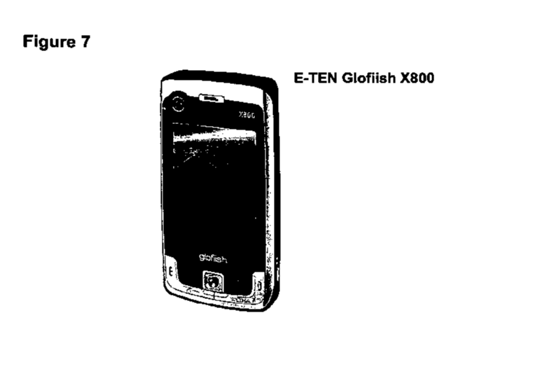

A third embodiment is disclosed, as an example, with reference to FIG. 7, where the MIP may be a smart phone (such as an ETEN X800) which has support for HSDPA and GSM850 onboard.

### Software

In a still further embodiment, software may be loaded onto a MIP by numerous methods, for example SD RAM card, or down loaded from the Internet. The software serves to replace various existing firmware of a mobile phone. The software provides a user interface, an audio function and a modem function. The software does not enable the circuit switched function of the phone. In accordance with the present invention, the audio function enables audio data to be provided to and from the packet switched function of the phone. The modem enables a packet switch connection to be established with a telecommunications network.

To successfully allow a MIP to make calls using the packet switch technology the following steps had to be carried out.

### Fourth Embodiment

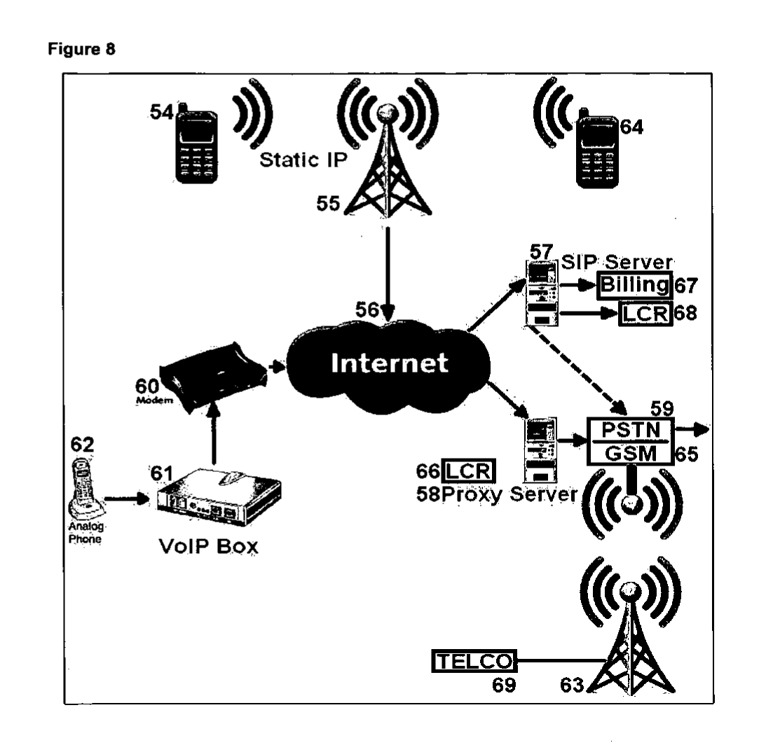

A fourth embodiment is disclosed, as an example, with reference to FIG. 8. MIP (54) have a SIM card in them with an access point name (APN) for example “moip”. This allows the MIP to be directly tied to the “moip” network wirelessly (55) as described in previous embodiments. A unique Static IP address is preferably assigned to each and every SIM card on the “moip” network. This allows a virtual private network to be created in which the only MIP devices (54,64) (phones) allowed access to the “moip” network are devices registered and authorised to use the “moip” .network. In this way, a relatively secure network is established and proper billing (67) processes and usage monitoring can be established. Once on the “moip” network, a device may establish communications with another device via the “moip” Session_Initiation_Protocol (SIP) server (57). The “moip” SIP server (57) verifies the transaction type and routes it to the appropriate connection type (64, 59, 65). In the case of a phone call (54), the SIP server (57) may connect the device (54) to another device (64) on the “moip” network or it may seek to make a connection outside (59,65) of the “moip” network. In the case where connections are required outside of the “moip” network a gateway (59, 65) connection is made and the appropriate path via PSTN (59) or GSM (65) gateway is determined using least cost routing (68) (LCR). If the gateways (59, 65) are under the control of the “moip” network, then the LCR function (68) will be carried out in conjunction with the SIP server function. If the gateways are externally provisioned via a SIP proxy (58) the outsourced the LCR function (66) with rest with the provider of this external function.

In this way calls are made from the MIP devices (54,64) on the “moip” network to external devices (63,69).

In bound calls are simply terminated at the “moip” SIP server (57) and routed to the respective IP address(es) associated with the respective direct-in-dial (DID) number(s) on the MIP devices (54,64).

The static IP address allows for relatively rapid device identification, verification and location on the “moip” VPN, and calls originating outside of the “moip” network are thus terminated at the “moip” SIP server (57) and converted from the conventional voice service to voice over IP protocol and routed to the respective static IP address on the “moip” VPN, in this case a phone type device (54, 64).

A fixed IP has also been found to improve power utilisation (improves battery life). Additional power savings may be applied by dropping into 2G mode whilst in an idle state (i.e. between calls) and requesting 3G or better when a call is in progress or about to be initiated. In addition to this, additional power savings may be achieved by using CODECs better suited to 2G networks such as the AMR (adaptive multi-rate) CODEC.

### Choosing Session Protocol

To allow the MIP to make calls over a packet switched network, our first step was to choose the protocol for the communication session. SIP (Session Initiation Protocol) was chosen as the protocol as it allows us to set up and tear down multimedia communications sessions such as voice and video calls over the Internet. Having chosen the SIP as the session protocol, our next step was to choose a SIP provider and as a result GoTalk™ was chosen as our preferred provider due to the low costs and high performance.

### Transport Protocol

Since the voice has to be transmitted in the form of packets, our next step was to choose a standard format for delivering the voice packets. RTP (Real Time Protocol) was chosen as the transport protocol for the transmission of the voice packets. RTP components include: a sequence number, which is used to detect lost packets; payload identification, which describes the specific media encoding so that it can be changed if it has to adapt to a variation in bandwidth; frame indication, which marks the beginning and end of each frame; source identification, which identifies the originator of the frame; and intramedia synchronization, which uses timestamps to detect different delay jitter within a single stream and compensate for it. To implement the RTP on the MIP, oRTP library which is written in C was chosen as it is easy to use and provides a packet scheduler for sending and receiving packets on time, adaptive jitter compensation, automatic sending of RTCP compound packets, and the RTCP parser API. It works with IPv6 as well.

### Streaming of Audio

Now, we had to install an application on the MIP that would allow us to create streams of the voice that has to be transmitted during the call. To do this, the application mediastreamer2 was first installed. mediastreamer2 is a powerful engine to make audio and video streams.

Mediastreamer2 carries out the following functions:
Read/Write from to an alsa device or an oss device
Send and receive RTP packets
Encode and decode the following formats: speex, G711, GSM, H263, theora.
Read and write from/to a wav file
Echo cancelation, using the extraordinary echo canceller algorithm from the speex library

### Audio Codec

Our next step was to choose a codec that would allow us to compress the voice considerably. Speex which is an open-source audio compression format was chosen as it is designed to compress voice at bitrates ranging from 2 to 44 kbps. Some of Speex's features include:
Narrowband (8 kHz), wideband (16 kHz), and ultra-wideband (32 kHz) compression in the same bitstream
Intensity stereo encoding
Packet loss concealment
Variable bitrate operation (VBR)
Voice Activity Detection (VAD)
Discontinuous Transmission (DTX)
Fixed-point port
Acoustic echo canceller
Noise suppression

### Making Calls

After installing the above mentioned applications. our next and final step was to use a library that would allow us to register to the SIP provider and make calls using a virtual phone. This was accomplished with the help of the library liblinphone which combines all the application features mentioned above and allows us to successfully register to our SIP provider and stay connected to them.

Thus by following the steps mentioned above we were able to successfully route the voice during a call in the form of packets thereby converting the MIP into a SIP phone that use the packet switching technology to make calls.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), an SDRAM Card, or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), SDRAM Card, or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A mobile telecommunications device comprising:
a first interface adapted to communicate with a telecommunications network
a second interface adapted to receive and/or transmit audio communication and provide audio data,
wherein the mobile device is adapted to transcribe the audio data into an IP packet.

2. A method of transcribing an audio signal for communication with a telecommunications network, the method comprising:
providing audio data
providing an encoded signal by incorporating the audio data into an IP packet compatible with the network.

3. A method as claimed in claim 2, wherein the audio data is provided by an audio codec.

4. A method as claimed in claim 2, wherein the IP packet is provided by the telecommunications network.

5. A method as claimed in claim 2 wherein the encoded signal is transmitted using a real time protocol.

6. A method as claimed in claim 2, further comprising the step of transmitting the encoded signal.

7. A method of communicating on a telecommunications network, the method comprising the steps of:
Providing an IP address to a MIP
Establishing a SIP session with a carrier service provider
Enabling audio traffic as packet data between the network and the MIP.

8. A method as claimed in claim 7, further comprising the step of providing concurrent sessions for a plurality of devices.

9. A method as claimed in claim 7, wherein a DID is assigned to an IP address.

10. A method as claimed in claim 7, wherein a DID is assigned to a plurality of IP addresses.

11. A method as claimed in claim 7, wherein an IP address is assigned to a plurality of DIDs.

12. A method as claimed in claim 7, wherein a plurality of IP addresses is assigned to a plurality of DIDs, for example in the case of a conference call.

13. A telecommunications system, comprising:
a mobile device adapted to communicate audio communication
the telecommunications network being adapted to provide packet data to and from the mobile device
wherein the packet data is derived from the audio communication.

14. A system as claimed in claim 13, wherein the network communicates with the Internet.

15. A system as claimed in claim 13, wherein packet data is transmitted in accordance with a real time protocol.

16. A telecommunications apparatus comprising:
processor means adapted to operate in accordance with a predetermined instruction set,
said apparatus, in conjunction with said instruction set, being adapted to perform the method as claimed in claim 2.

17. A computer program product comprising:
a computer usable medium having computer readable program code and computer readable system code embodied on said medium for enabling functionality of a telecommunications apparatus, said computer program product including:
computer readable code within said computer usable medium for adapting the apparatus to operate in accordance with claim 2.

18. A method as herein disclosed.

19. An apparatus and/or device as herein disclosed.
